(19) United States
(12) Patent Application Publication
(10) Pub. No.: US 2009/0008500 A1
(43) Pub. Date: Jan. 8, 2009

(54) Radial venturi wing machine; apparatus for improved aircraft flight

(76) Inventor: Phillip Richard Barber, Santa Ana, CA (US)

Correspondence Address: QUICKPATENTS, INC., 32861 CALLE PERFECTO, SUITE A, SAN JUAN CAPISTRANO, CA, 92675, US

(21) Appl. No.: 11/825,529

(22) Filed: Jul. 6, 2007

(51) Int. Cl. B64C 27/00

(52) U.S. Cl. 244/39

(57) ABSTRACT

Radial Venturi Wing machine, apparatus for improved aircraft flight with a circular wing, a round wing, and a circular fan having its blades affixed at the perimeter of the circle as opposed to its axis.

A simple demonstration of this innovation is placing a piece of paper in front of the intake side of a box type fan.

The Radial Venturi Wing utilizes this principle by replacing the box around the fan with a circular wing, the paper being pulled toward the fan blade by a, round wing, fan blades by a fan disc.

The fan disc draws the air over the surfaces of the two wings causing lift.

Air pulled thru the gap between the wings causes a low pressure area under and over the center of the venturi wing causing lift.

The downward disc fan thrust causes additional lift.

Air pulled thru the gap between the wings causing a venturi effect.

### CROSS REFERENCE TO RELATED APPLICATIONS

This is a continuation of Ser. No. 591,583, filed on Dec. 13, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates to machines for flight generally, and more particularly to improvements in direct lift type of aircraft.

Previous aircraft propel a wing thru the air to cause lift or thrust.

The Radial Venturi Wing moves the air over the wings causing lift.

The first technology was the airplane wing, as developed by Orville and Wilbur Wright. In which lift is created by moving the wing thru the air. The shape of the wing causing a low pressure area above the wing thereby creating lift. The forward energy provided by internal combustion engines and the propeller.

The next significant improvement was the helicopter. In which the propeller and the wing are combined and mounted to the top of the aircraft. When rotated at high speeds, the wing creates lift and thrust.

Previous aircraft propel a wing thru the air to cause lift or thrust. A very inefficient use of energy.

The Radial Venturi Wing directs air flow over the wings causing lift. Optimizing energy use.

The helicopters speed is limited by return rotor stall. The Radial Venturi wing solves this problem by wrapping the wing around the rotor blade.

The helicopters exposed rotor blades cause an inherent safety risk. The Radial Venturi wing solves this problem by wrapping the wing around the blade.

### BRIEF SUMMARY OF THE INVENTION

The primary advantage of the invention is to improve efficiency of the rotor by directing air flow over the surface of a wing.

Another advantage of the invention is to solve the speed limiting problem on helicopters of rotor stall caused by the trailing rotor, by wrapping the wing around the rotor.

Another advantage of the invention is to improve efficiency of airflow and energy by directing air flow thru a venturi gap.

A further advantage of the invention is to provide a readily adaptable design to both fixed wing and rotor equipped aircraft.

Yet another advantage of the invention is to provide a safer method of direct lift aircraft by wrapping a wing around the rotor blades.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed the Radial Venturi Wing machine, apparatus for improved aircraft flight comprising: a circular wing hereinafter referred to as a Radial wing, a round wing, and a circular fan having its blades affixed at the perimeter of the circle as opposed to its axis.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cross sectional view of the Radial Venturi Wing; showing the airflow being directed through the venturi gap caused by the clearance between the upper venturi wing and the lower radial wing; the low pressure areas caused by the shape and position of the wings; the airflow being initiated by the disc fan; the downward thrust caused by the disc fan also being shown.

FIG. 2 is a top view of the Radial Venturi Wing; showing the Radial wing wrapped around the disc fan; the venturi wing positioned over the Radial wing (shown as the darkened area), and the Disc fan; the Disc Fan position being in the center of the Radial wing and centered under the Venturi wing; further showing the blades of the disc fan being affixed to the rim of the disc providing the advantage of improved balance and vortex action.

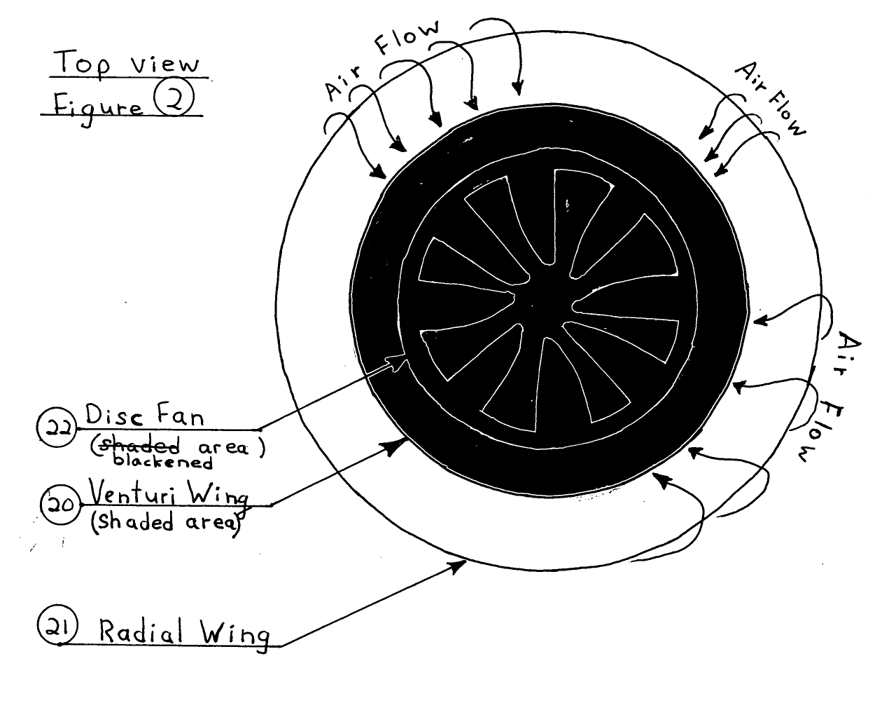

FIG. 3 is a perspective view of the Radial Venturi Wing; the Radial Wing and the Venturi Wing in their relative position to each other.

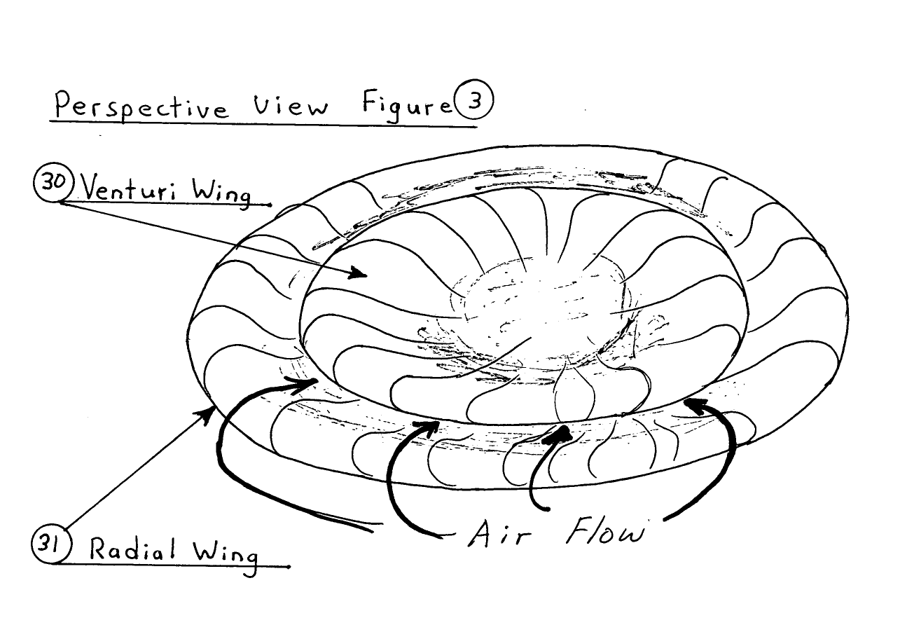

FIG. 4 is a cross sectional view of the Radial Venturi Wing; being shown in an adaptive retrofit to a typical helicopter.

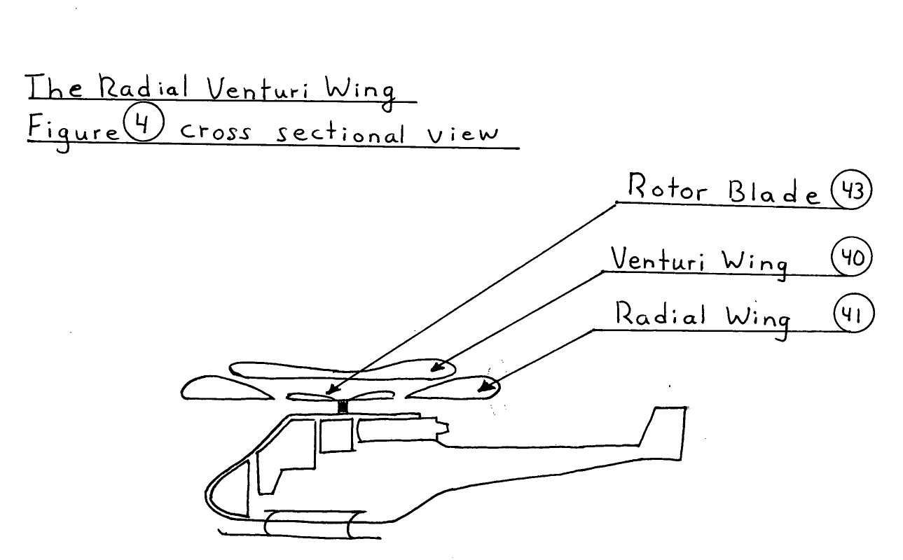

FIG. 5 is a top view of the Radial Venturi Wing; being shown in an adaptive form to a fixed wing aircraft.

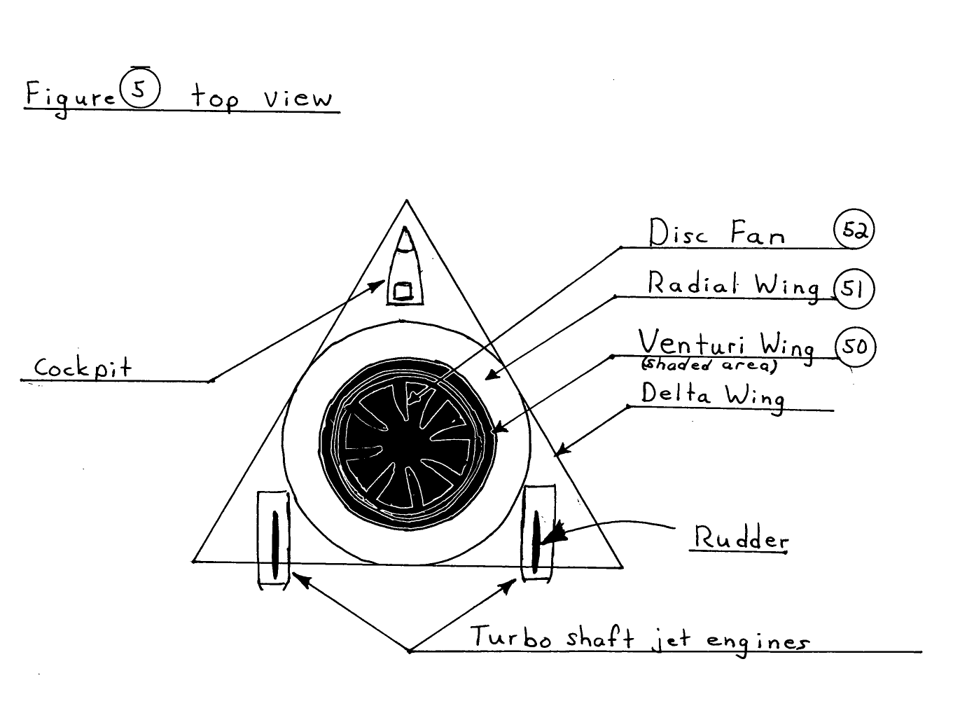

FIG. 6 is a top view of the Radial Venturi Wing; being shown in an adaptive form to a fixed wing aircraft.

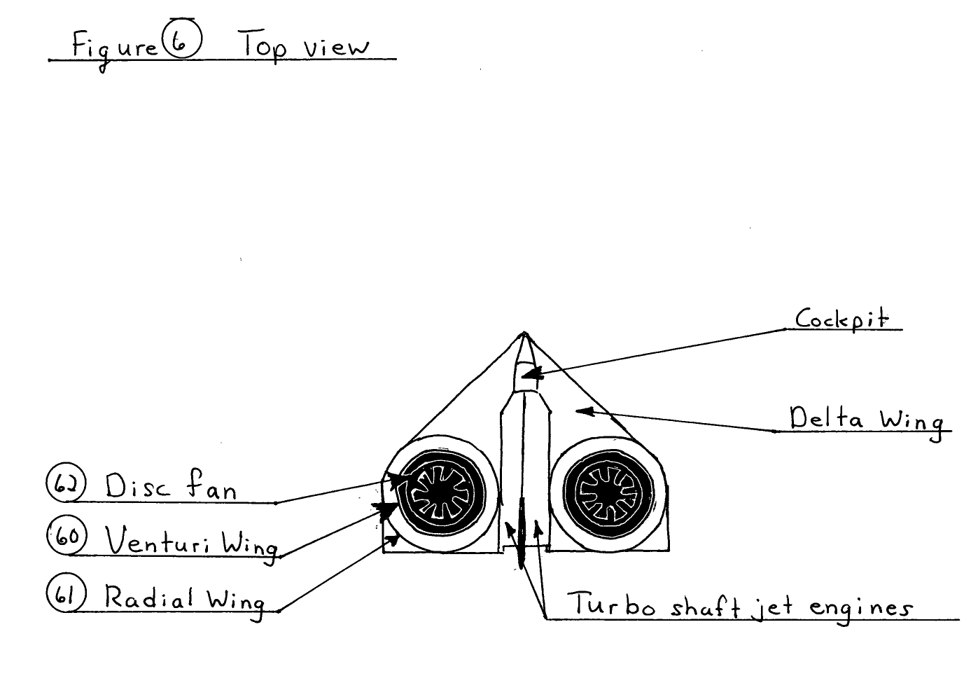

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

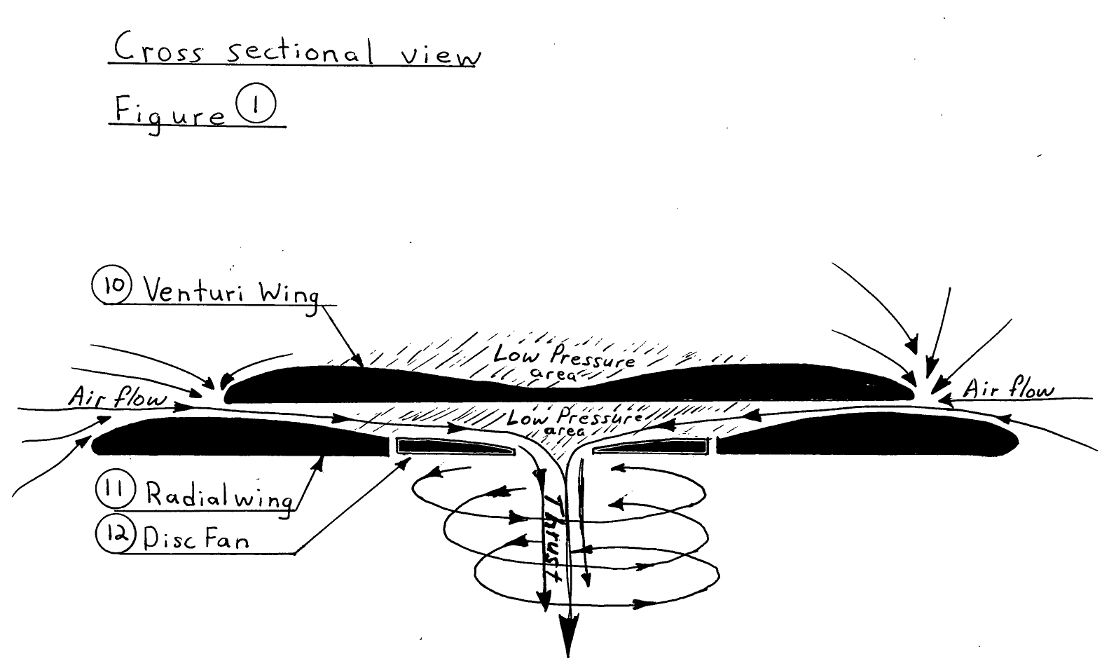

In accordance with an important feature of the present invention, there is disclosed the Radial Venturi Wing machine apparatus for improved aircraft flight; as in claim A1 comprising: turning first to FIG. 1 there is shown element 10 the venturi wing a round wing; positioned over the center of element 11 the Radial wing a wing forming a circle; having positioned in its center, element 12 the Disc fan comprising of individual propeller blades being affixed to the rim perimeter as opposed to an axle at its axis.

Said disc fan rotating so as to direct thrust downward while simultaneously directing air flow over said Radial wing thru the venturi gap as provided by said Venturi wing centered over said radial wing; causing lift. Additional lift caused by low pressure area in the center of said Venturi wing.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Radial Venturi Wing machine; Apparatus for improved aircraft flight comprising: a circular wing; a round wing; and a circular fan having its blades affixed at the perimeter of the circle as opposed to its axis.
